(19) United States
(12) Patent Application Publication
(10) Pub. No.: US 2003/0094148 A1
(43) Pub. Date: May 22, 2003

(54) Securing device involving a piston propelled by compressed gas

(75) Inventor: Bruno Toulouse, Valence (FR)

Correspondence Address: LOWE HAUPTMAN GILMAN & BERNER, LLP, Suite 310, 1700 Diagonal Road, Alexandria, VA, 22314, US

(73) Assignee: SOCIETE DE PROSPECTION ET D'INVENTIONS TECHNIQUES SPIT

(21) Appl. No.: 10/299,827

(22) Filed: Nov. 20, 2002

(30) Foreign Application Priority Data
Nov. 21, 2001 (FR) 01 15 052

(51) Int. Cl. F02B 71/00

(52) U.S. Cl. 123/46 R

(57) ABSTRACT

The device for securing a plug, of the type involving a piston (9) propelled by gas, comprises a combustion chamber (5) delimited on one side by the piston and on the other side by a cylinder head (7) with a duct (19) for injecting combustible gas open via one end (19A) into the chamber.

According to the invention, the duct (19) comprises a means for creating a pressure drop between the part of the duct (19) upstream of the said end (19A) and the chamber (5) itself, so as to at least partially avoid the vaporizing of the combustible gas in the said part of the duct upstream of the end.

The invention relates to a device for securing a plug with a motor involving a piston propelled by gas, particularly combustion gases. It is aimed in particular at a means improving the combustion inside the chamber in which the gases are produced.

A device of this type comprises a casing which has the overall form of a gun. This casing contains a small internal combustion engine which drives a plug guide in a translation movement. The plug guide is secured to a piston propelled by a compressed gas which is the product of the combustion of a combustible gas in the adjoining combustion chamber. The gaseous mixture comprising the air and the combustible gas is created in the chamber then ignited by an appropriate ignition means. The gun comprises a combustible-gas cartridge housed, for example, in the hand grip. When a plug is fired, a metered amount of combustible gas is sent into the chamber, then voltage is applied to the firing means. In devices known to the applicant company, the gas follows a path along the device from a metering valve near the gas cartridge to the combustion chamber. The gas is guided along a duct, generally a fine tube, arranged between the valve and the chamber.

With the devices found on the market, it is observed that there is a significant delay between the time of firing and the actual ejection of the plug. This delay may prove troublesome when the operator is in an uncomfortable position and the device is likely to move.

The applicant company has set its sights on reducing this reaction time as far as possible.

According to the invention, this result is achieved by incorporating a means that creates a pressure drop between the part of the tube upstream of its end near the combustion chamber and the chamber itself, so as to at least partially avoid the vaporizing of the gas upstream of the said end.

Such a means consists of a narrowing of the tube at its end, the tube has a side orifice.

What happens is that the gas is normally in the liquid state in the cartridge, and experiences expansion as it leaves the metering valve. It has been observed that, surprisingly, if the time of its vaporization prior to entering the chamber is delayed, the time that the device takes to react the squeezing of the trigger is reduced.

This result can be explained by the fact that there is a link between the vaporizing of the gas as it passes through the metered valve, and the time taken to fill the combustion chamber. With devices of the prior art, the time is relatively long. By contrast, with the solution of the invention, the gas is propelled in greater quantity and in a shorter time because it remains partially in the liquid state immediately upstream of the atomization orifice. The cycle time is thus reduced.

According to another characteristic, the cross section of the orifice or of the orifices is at least 10% less than the cross section of the duct.

Other characteristics and advantages of the invention will become apparent from reading the description which follows, which relates to one particular embodiment of a device, with reference to the appended drawings in which

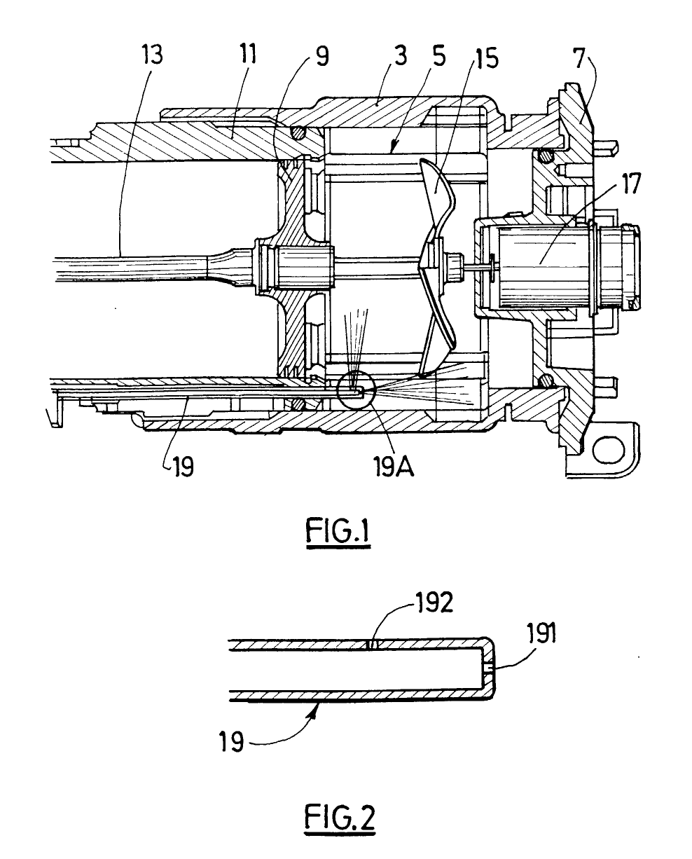

FIG. 1 depicts a part view in axial section of the device

FIG. 2 shows one example of the end of the chamber supply tube.

FIG. 1 shows the rear end of the device 1 without its case. The sleeve 3 of the combustion chamber 5, closed by a cylinder head 7 on one side and by a piston 9 on the other side may be seen. The piston 9 moves in translation in a cylinder 11 and is secured to a rod 13. This rod rests at its other end, not depicted, against a plug that is to be propelled. A blower 15 is mounted inside the chamber 5 and its function is to activate the mixing of the gases. It is driven by a motor 17 housed in the cylinder head 7. Its axis of rotation here lies in the continuation of the rod 13. The gaseous mixture is ignited by a means which has not been depicted and which lies in the region of the cylinder head, behind the blower.

A gas injection tube or duct opens into the combustion chamber. Its axis is roughly parallel to that of the rod 13. It is connected at its other end, not visible in the figure, to the metering valve. The latter is arranged in a housing of the device which is designed for that purpose.

FIG. 2 depicts an embodiment of the end 19A of the injection tube. This end shows an axial first orifice 191 which allows injection in the continuation of the duct 19 towards the blades of the blower. It also comprises an orifice 192. This orifice is placed on the wall of the tube 19 for radial injection parallel to the plane of the piston 9. According to the invention, the total of the cross sections of the orifices is less than the cross section of the tube, so as to create a pressure drop between the tube and the combustion chamber.

According to another embodiment, the tube is closed at its end via a transverse wall and has only openings made in the wall, laterally.

A tube according to the invention was made and used to replace the tube of an existing device.

The characteristic dimensions were as follows:

Internal cross section of the tube: 1.00 units (of area).

Cross section of the axial circular orifice: 0.35 unit.

Cross section of the lateral circular orifice: 0.50 unit.

The narrowing of the cross section of the duct was therefore 15%.

Comparative tests were carried out comparing the solution of the invention with that of the prior art. It was found that it was thus possible to increase for a firing rate of one shot per second to two shots per second without making any other modifications.

1. Device for securing a plug, of the type involving a piston (9) propelled by gas, comprising a combustion chamber (5) delimited on one side by the piston and on the other side by a cylinder head (7) with a duct (19) for injecting combustible gas open via one end (19A) into the chamber, characterized in that the duct (19) comprises at least a lateral orifice (192) near its end (19A) with a narrowed section creating a pressure drop between the part of the duct (19) upstream of the said end (19A) and the chamber (5) itself, so as to at least partially avoid the vaporizing of the combustible gas in the said part of the duct upstream of the end.

2. Device according to the claim 1, the duct comprising an axial orifice (191) at its end.

3. Device according to one of the preceding claim 1 or 2, the cross section of the orifice or of the orifices being at least 10% smaller than the cross section of the duct.

4. Device according to claims 1, 2 or 3, comprising a blower for mixing inside the combustion chamber, the duct comprising at least one orifice oriented in such a way as to direct at least some of the combustible gases injected into the chamber toward the blower (15).

5. Device according to the preceding claim, comprising a second orifice directing some of the combustible gases in a direction parallel to the plane of the piston (9).
